(19) United States
(12) Patent Application Publication
(10) Pub. No.: US 2014/0003706 A1
(43) Pub. Date: Jan. 2, 2014

(54) METHOD AND SYSTEM FOR ENSURING STEREO ALIGNMENT DURING PIPELINE PROCESSING

(71) Applicants: Alan L. Davidson, Sherman Oaks, CA (US); Parag Havaldar, Cerritos, CA (US); Peter H. Palombi, Los Angeles, CA (US)

(72) Inventors: Alan L. Davidson, Sherman Oaks, CA (US); Parag Havaldar, Cerritos, CA (US); Peter H. Palombi, Los Angeles, CA (US)

(73) Assignees: Sony Pictures Technologies Inc., Culver City, CA (US); Sony Corporation, Tokyo (JP)

(21) Appl. No.: 13/755,461

(22) Filed: Jan. 31, 2013

Related U.S. Application Data
(60) Provisional application No. 61/667,166, filed on Jul. 2, 2012.

(51) Int. Cl. G06K 9/00

(52) U.S. Cl. CPC G06K 9/00201
USPC 382/154

(57) ABSTRACT

Apparatus and methods are provided to implement a technique for adjusting images, such as for addressing lens distortions. In one implementation, a computer system uses un-warping to address differences between two camera lenses. After unwarping two stereo images, the images are re-warped but re-warped using a common set of parameters.

### CROSS-REFERENCE TO RELATED APPLICATIONS

This application claims benefit of priority from U.S. Provisional Patent Application Ser. No. 61/667,166, filed Jul. 2, 2012, entitled “Warping Lenses to Match Vertically”, assigned to the assignee of the present application and herein incorporated by reference in its entirety.

### BACKGROUND

The process of modern motion picture production typically involves many steps of a pipeline. For example, an initial step is performed by a film department that generates products including film plates. A film input/output department produces digital plates that are digitally scanned from the film plates.

The digital plates may then be subject to numerous types of processes, e.g., plate preparation, visual effects, or the like. Visual effects may take advantage of methods such as match moving, animating, layout compositing, and so on.

In the case of stereo content, similar same steps may be followed, but the process is naturally more complex because two sequences of images are employed.

In more detail, natively-shot stereo content, where two cameras are capturing images together, employs a rig with two cameras on a mount and the cameras are intended to be the same. In practice, however, no two cameras are exactly alike and neither are the lenses that they use, though generally the cameras and lenses are close in parameters. The lens difference, however minor, can serve as a visual distraction in viewing stereo content, as two different lenses can introduce disparities, especially vertical disparities, making content difficult to view in stereo. In some cases, vertical disparities have been associated with eyestrain, annoyances or even headaches in viewers, as viewers attempt to fuse the images properly in the vision process.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Systems and methods according to principles disclosed here in part alleviate such difficulties. In one implementation, stereo images are un-warped for each camera separately, so that all the front-end pipeline tasks may be well-composed stereoscopically. Such front-end pipeline tasks may include match-moving, plate preparation, animation, layout, and the like. After the left and right views are unwarped and the tasks performed, lens warps may be introduced back into the views, i.e., re-warping both stereoscopic images, to provide a natural-looking image. However, each individual view's distortion parameters are not employed separately to re-warp each image. Rather, one common lens distortion transformation is employed to re-warp the images. The common lens distortion employed may be that of the left camera or of the right camera, and the choice may be dependent on which has an artistically preferred view, on the stereo capture rig used, or on other bases. Using just one lens distortion warp preserves all the vertical alignment of content that was maintained throughout the various tasks performed, i.e., throughout various stages of the pipeline.

In one aspect, the invention is directed towards a method for adjusting images, including: recording a first image with a first camera having a first lens distortion; recording a second image with a second camera having a second lens distortion; unwarping the first image with a first lens distortion transformation; unwarping the second image with a second lens distortion transformation; rewarping the first image using a common lens distortion transformation; and rewarping the second image using the common lens distortion transformation.

Implementations of the invention may include one or more of the following. The common lens distortion transformation may be an inverse transformation of the first lens distortion transformation or the second lens distortion transformation, and may further be a linear combination of an inverse of the first lens distortion transformation and an inverse of the second lens distortion transformation. Alternatively, the same may be an average of the first lens distortion transformation and the second lens distortion transformation. The method may further include changing the first or second images, or both, before warping the first image. The changing step may include a step of match-moving, plate preparation, animating, compositing, or rendering.

In another aspect, the invention is directed towards a non-transitory computer readable medium, including instructions for causing a computing environment to perform the above method.

In a further aspect, the invention is directed towards a system for adjusting images, including: an input module for receiving a first image with a first camera having a first lens distortion and for receiving a second image with a second camera having a second lens distortion; an unwarping module for unwarping the first and second images using transformations corresponding to the first and second lens distortions; and a warping module for re-warping the first and second images with a common lens distortion transformation.

Implementations of the invention may include one or more of the following. The system may further include a selection module for receiving an input from a user indicating a common lens distortion transformation to employ in the re-warping. The selection module may display a choice of an inverse of the first lens distortion transformation or an inverse of the second lens distortion transformation to use as the common lens distortion transformation. The selection module may further or in addition display a choice of a linear combination of an inverse of the first lens distortion transformation and an inverse of the second lens distortion transformation to use as the common lens distortion transformation. The selection module may also display a choice of an average of the inverse of the first lens distortion transformation and the inverse of the second lens distortion transformation to use as the common lens distortion transformation. The system may further include a modification module for performing a task on the unwarped images. The modification module may be configured to perform a step of match-moving, compositing, plate preparation, animating, rendering, or compositing on one or both of the first or second unwarped images.

Advantages of certain implementations of the invention may include one or more of the following. Significantly-improved stereo results may be obtained in a convenient fashion. Vertical disparities in images are reduced or eliminated. Other advantages will be apparent from the description that follows including the figures and claims.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates transformations of two stereo images due to un-warping and re-warping. FIG. 1 also shows the effect of re-warping with a common lens distortion transformation.

FIG. 2 is an exemplary flowchart detailing a method according to certain principles described here.

FIG. 3 illustrates an exemplary modular system according to certain principles described here.

FIG. 4 illustrates an exemplary computing environment which may be employed to perform methods according to certain principles described here.

Like reference numerals refer to like elements throughout. Elements are not drawn to scale unless otherwise indicated.

### DETAILED DESCRIPTION

Physical lenses generally create some degree of distortion in their resulting images. This is in contrast to pinhole cameras, which have no lens, and which can create images without distortion, where distortion is often exemplified by where straight lines in a scene become curved in an image of the scene. Distortion is a characteristic of all lenses but is often particularly pronounced with short lenses. Distortions are more apparent at the periphery of the lens, which maps to the edges or boundary of the image. Examples of types of distortion include pincushion, barrel, and perspective distortion.

Distortion can be corrected to some degree using various known models. In this specification such correction is known as un-warping but may also be thought of as warping with a reverse distortion. Such un-warping involves calculating how distorted pixels correspond to un-distorted ones and generally involves calculation of a series of coefficients in an expansion. Once the coefficients are known, an inverse distortion (“re-warping”) can be calculated, the re-warping to re-institute distortion back into the image. It is generally desirable to do so because a viewer's eyes expect to see certain distortions, and/or certain distortions create a desirable visual effect.

It is noted in this regard that the distortions described above are there by design in how lenses work. And such distortion, however small, must be removed for any metric analysis such as in a visual effects pipeline and reapplied again. But a more perceptually troubling phenomenon can occur in the case of stereo photography where two lenses are used. There are bound to be slight differences between similarly manufactured lenses, slight differences in the way they are mounted ultimately causing dissimilar distortions in the two images which is perceptually troubling. For example, even slight variations in vertical positioning (“verticality”) of right and left images can cause annoyance to a viewer.

In addition, certain processing or preprocessing steps are difficult to perform on images with distortions because, for example, the operator cannot easily match up corresponding straight lines, e.g., edges of a building, if such lines appear curved. This effect can easily complicate processes such as plate preparation, match moving, animation, layout, or the like. In addition, effects created with CG cameras, e.g., placement of a CG object in a scene imaged by stereo plates, are preferably inserted on unwarped plates because the CG cameras themselves, modeling perfect pinhole cameras, take any points within their field of view and placed the same on an image plane without any distortion. As such, they do not experience warping.

In addition, placing such CG objects requires accurate determination of camera location, termed “camera extraction”. Un-warping allows more accurate determination of the location of the stereo cameras, from which positioning of the CG cameras is derived.

Thus, certain implementations of the present invention call for such operations to be performed on unwarped images. In other words, a step of un-warping is performed for both images of a right and left stereo pair. The form of the un-warping transformation for each lens is generally different as the physical lens characteristics are generally different. In one implementation, an optimum set of coefficients is determined for un-warping, to whatever degree of expansion is deemed sufficient. This step is repeated for each lens. In one method of determining an un-warping transformation, when a camera is not being used for filming, the same is used to image a known grid at a known distance. By determining how the grid lines undergo a transformation in the image, the amount and type of warping can be determined The process of un-warping basically moves points in an image to locations where they would be placed if the cameras were perfect pinhole cameras.

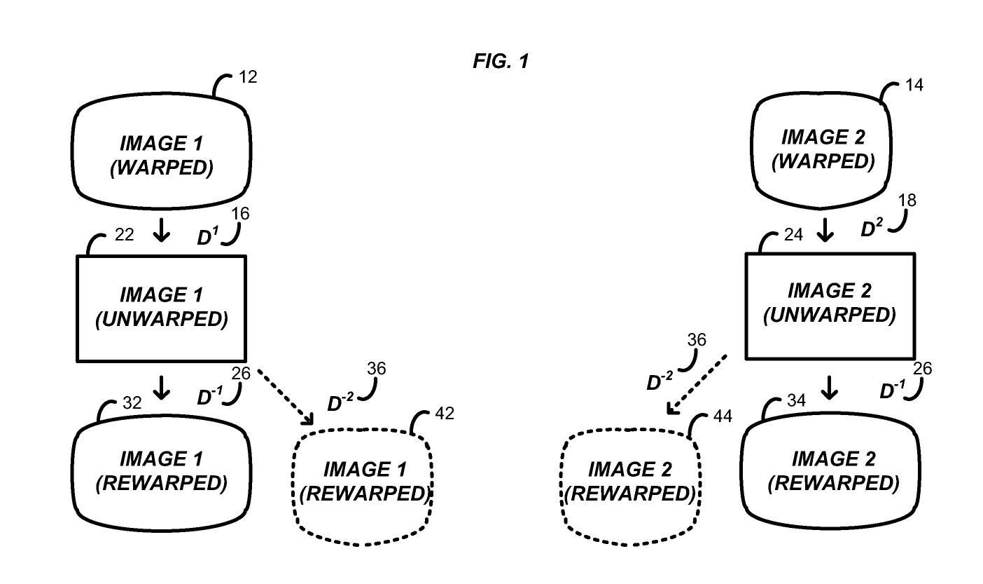

Referring to FIG. 1, a left image (image 1) 12 is pictured that has a degree of warping or distortion. A corresponding right image (image 2) 14 is similarly pictured. A transformation D¹ 16 may be employed to transform the warped image 12 into an unwarped image 22. In the same way, a transformation D² 18 may be employed to transform the warped image 14 into an unwarped image 24. Various changes or other processing steps may then be performed on the unwarped images. Such processing may include plate preparation, match moving, layout, animation, rendering, compositing, and so on. As noted above, having the images unwarped allows such processing steps to proceed in a more accurate manner. However, such unwarped images may not appear correct to a viewer's eyes, and a step of re-warping is then performed.

Such a re-warping is illustrated in FIG. 1 by transformation D⁻¹ 26 or D⁻² 36. D⁻¹ 26 and D⁻² 36 represent inverse transformations to transformations D¹ 16 and D² 18, respectively. The transformation D⁻¹ 26 transforms the unwarped image 22 into a re-warped image 32. Importantly, the same transformation D⁻¹ 26 is employed to transform the unwarped image 24 into a re-warped image 34. In the same way, a common transformation D⁻² 36 may be employed to transform the unwarped image 22 into a re-warped image 42 and in such situations the common transformation D⁻² 36 would also transform the unwarped image 24 into a re-warped image 44.

While the use of one of the inverse transformations D⁻¹ 26 and D⁻² 36 as a common transformation have been found appropriate for re-warping purposes, it will be understood that in some cases other common transformations may be employed, including transformations that represent an “average” or other linear combinations of inverse transformations D⁻¹ 26 and D⁻² 36. In some stereo rigs, one camera is a “main” camera, and transformations based on the same may then be employed. For example, some stereo rigs have cameras placed perpendicularly to each other and a beam splitter is used to deliver the images to the cameras. Such systems are beneficial in that the stereo separation of the images is controllable down to even a separation distance of zero. In this case, it may be desired to use a transformation based on the lens distortion of the camera whose image did not undergo a step of reflection in the beam splitter. However, in general, the distortion of any of the stereo cameras may be employed in the re-warping transformation.

Numerous advantages inure to using a common transformation. For example, use of a common transformation ensures that any visual effects added to the scene during processing in the pipeline, e.g., CG elements added using match moving, will have the same transformation applied and will thus not be distorted in different ways from the left image to the right image. Use of the same transformation ensures that efforts to maintain properly aligned vertical positioning of objects will not be undone by the re-warping process, i.e., will not result in vertical disparities due to different transformations be applied to the respective images.

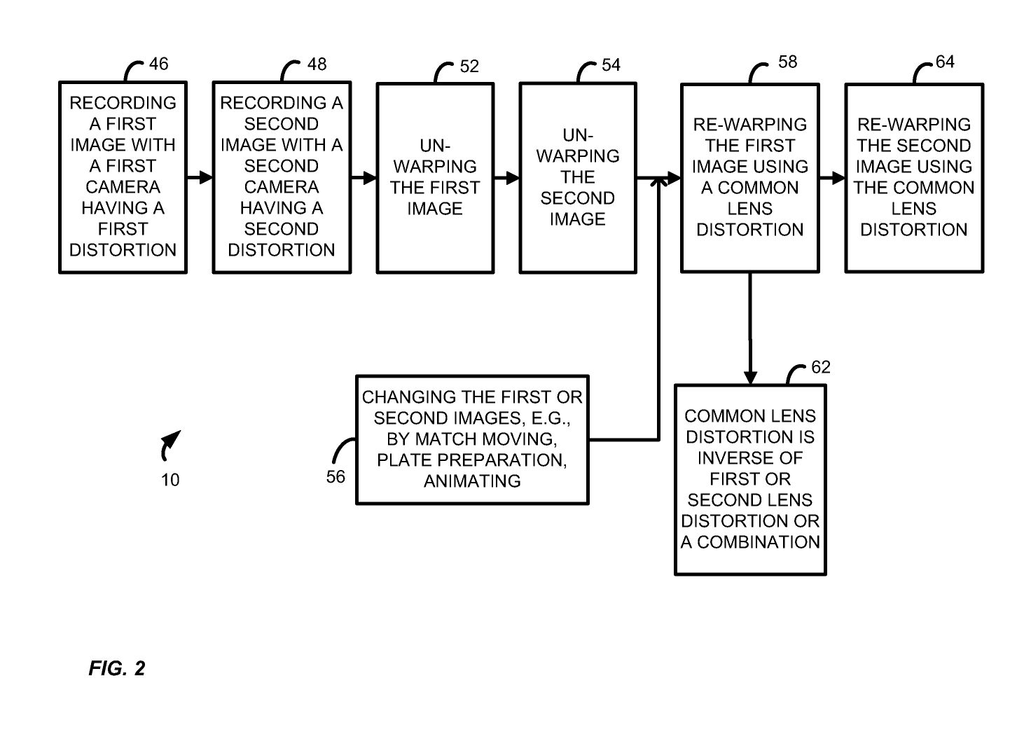

Referring to FIG. 2, a flowchart 10 is illustrated for performing a method according to certain principles disclosed here. In a first step, a first image is recorded with a first camera having associated a first distortion therewith (step 46). Similarly, for stereo photography, a second image is recorded with a second camera, the second camera having a second distortion associated therewith (step 48). The first image is then unwarped (step 52) using a transformation such as an algorithm that removes the distortion due to the physical lens, e.g., a lens correction algorithm, using, e.g., parameters determined using a grid as noted above. Similarly, the second image is unwarped using the same principles (step 54).

At this point the first or second images may be changed, e.g., modified or added to in some way by a processing step (step 56). Typical processing steps include a step of match moving, plate preparation, or other visual effects may be added. Rendering and compositing may likewise occur.

The processed images are then re-warped. In particular, the first image is re-warped using a common lens distortion transformation (step 58). The common lens distortion transformation may be the inverse of the first distortion, the inverse of the second distortion, or a transformation corresponding to some average of the two or other such linear combination (step 62). The second image is re-warped using the same common lens distortion transformation (step 64).

Using the method according to FIG. 2, images from stereo cameras may be processed or otherwise operated on in a manner that allows significantly-enhanced processing while reducing undesirable artifacts such as vertical disparities in the stereo images.

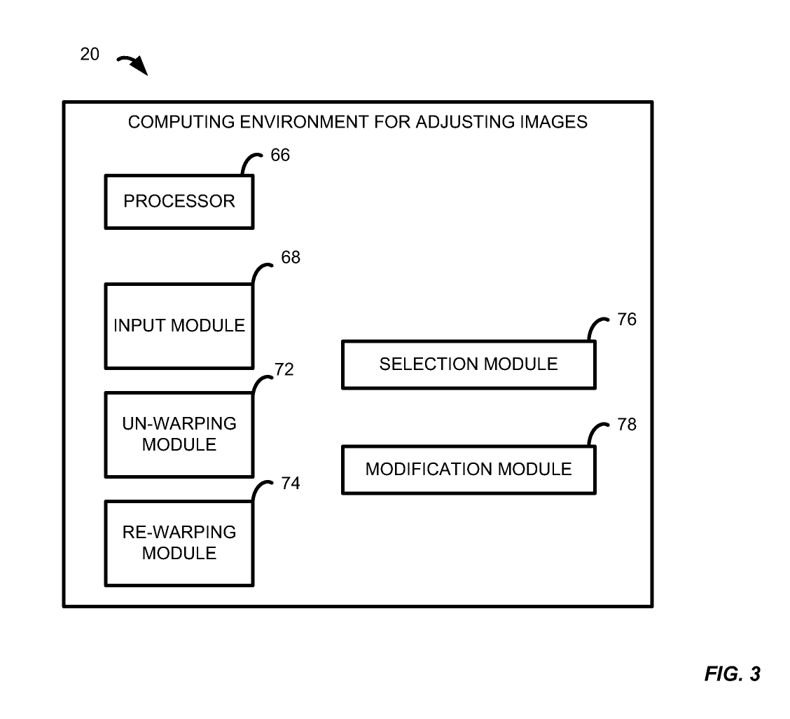

FIG. 3 illustrates a modular system according to principles disclosed here. The computing environment 20 of FIG. 3 is implemented in terms of modules, e.g., software modules, but the same may also be implemented in hardware or firmware. The computing environment 20 may also be implemented in terms of memory comprising instructions for performing the functions described in the modules. It will be understood that the modules or memories may be distributed over any number of physical systems, but in many cases form part of a single animation workstation.

The computing environment 20 includes a processor 66 for executing instructions sent to it by the various modules. The environment 20 includes an input module 68 for receiving first and second images from first and second cameras. An un-warping module 72 is provided to remove the distortions present in the first and second images. The un-warping module 72 may perform its functions using a number of types of distortion removing subroutines, e.g., those relying on Brown's distortion model.

One or more modification modules 78 may be provided to perform various changes, modifications, or other processing steps on the unwarped first and second images. Such steps include plate preparation, match moving, animation, layout, rendering, compositing, or other visual effects.

Following modification by the modification modules 78, a step of re-warping is performed by a re-warping module 74. A selection module 76 may control how the re-warp is performed, including which inverse distortion transformation is employed to put a lens distortion back into the images.

What has been described are systems and methods for improving various pipeline tasks by performing the same on unwarped images, followed by re-warping the images with a common distortion, rather than individual distortion transformations. In this way, vertical and other disparities that may otherwise have appeared are removed, such disparities being associated with difficult-to-view stereo images.

One implementation includes one or more programmable processors and corresponding computer system components to store and execute computer instructions, such as to provide the tools for unwarping and rewarping with a common distortion transformation. One such computing environment is disclosed below.

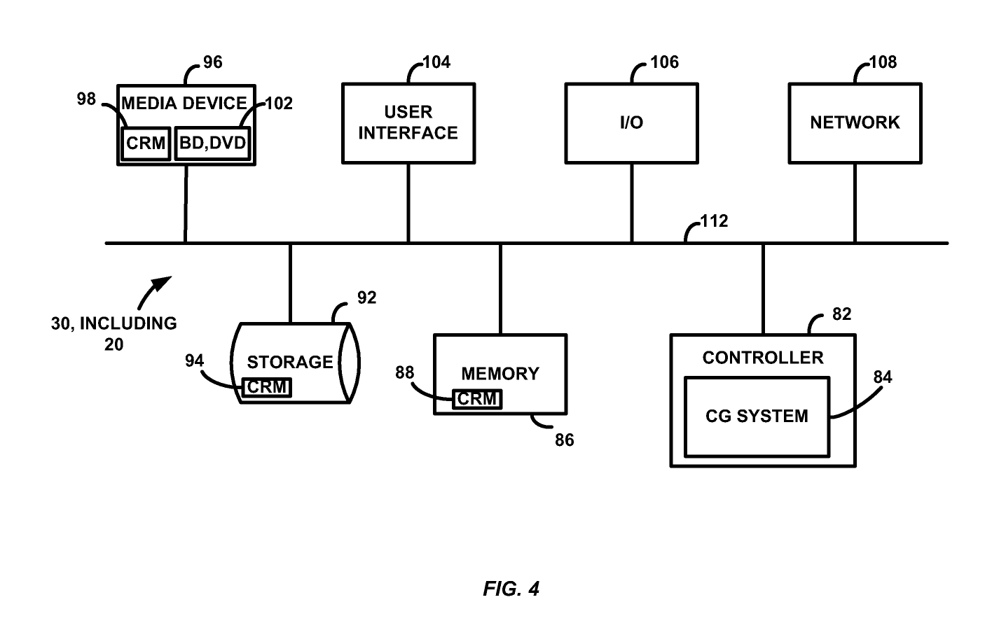

Referring to FIG. 4, a representation of an exemplary computing environment 30 for a computer graphics workstation is illustrated.

The computing environment 30 includes a controller 82, a memory 86, storage 92, a media device 96, a user interface 104, an input/output (I/O) interface 106, and a network interface 108. The components are interconnected by a common bus 112. Alternatively, different connection configurations can be used, such as a star pattern with the controller at the center.

The controller 82 includes a programmable processor and controls the operation of an computer graphics system 84. The controller 82 loads instructions from the memory 86 or an embedded controller memory (not shown) and executes these instructions to control the system.

Memory 86, which may include non-transitory computer-readable memory 88, stores data temporarily for use by other components of the system. In one implementation, the memory 86 is implemented as DRAM. In other implementations, the memory 86 also includes long-term or permanent memory, such as flash memory and/or ROM.

Storage 92, which may include non-transitory computer-readable memory 94, stores data temporarily or long-term for use by other components of the system, such as for storing data or instructions. In one implementation, the storage 92 is a hard disc drive or a solid state drive.

The media device 96, which may include non-transitory computer-readable memory 98, receives removable media and reads and/or writes data to the inserted media. In one implementation, the media device 96 is an optical disc drive or disc burner, e.g., a writable Blu-ray® disc drive 102.

The user interface 104 includes components for accepting user input, e.g., the user indication of common lens distortions or other aspects discussed above, and presenting a display, e.g., of unwarped or re-warped images, to the user. In one implementation, the user interface 104 includes a keyboard, a mouse, audio speakers, and a display. The controller 82 uses input from the user to adjust the operation of the computing environment.

The I/O interface 106 includes one or more I/O ports to connect to corresponding I/O devices, such as external storage or supplemental devices, e.g., cloud storage devices, a printer or a PDA. In one implementation, the ports of the I/O interface 106 include ports such as: USB ports, PCMCIA ports, serial ports, and/or parallel ports. In another implementation, the I/O interface 172 includes a wireless interface for wireless communication with external devices.

The network interface 108 allows connections with the local network and includes a wired and/or wireless network connection, such as an RJ-45 or Ethernet connection or “Wi-Fi” interface (802.11). Numerous other types of network connections will be understood to be possible, including WiMax, 3G or 4G, 802.15 protocols, 802.16 protocols, satellite, Bluetooth®, or the like.

The system may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and are within the scope of the present invention. For example, the disclosed systems and methods can be applied to images from movies, television, video games, etc.

Accordingly, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for adjusting images, comprising:
a. recording a first image with a first camera having a first lens distortion;
b. recording a second image with a second camera having a second lens distortion;
c. unwarping the first image with a first lens distortion transformation;
d. unwarping the second image with a second lens distortion transformation;
e. rewarping the first image using a common lens distortion transformation; and
f. rewarping the second image using the common lens distortion transformation.

2. The method of claim 1, wherein the common lens distortion transformation is an inverse transformation of the first lens distortion transformation or the second lens distortion transformation.

3. The method of claim 1, wherein the common lens distortion transformation is a linear combination of an inverse of the first lens distortion transformation and an inverse of the second lens distortion transformation.

4. The method of claim 3, wherein the common lens distortion transformation is an inverse of an average of the first lens distortion transformation and the second lens distortion transformation.

5. The method of claim 1, further comprising changing the first or second images, or both, before warping the first image.

6. The method of claim 5, wherein the changing includes a step of match-moving.

7. The method of claim 5, wherein the changing includes a step of plate preparation.

8. The method of claim 5, wherein the changing includes a step of animating.

9. The method of claim 5, wherein the changing includes a step of compositing.

10. The method of claim 5, wherein the changing includes a step of rendering.

11. A non-transitory computer readable medium, comprising instructions for causing a computing environment to perform the method of claim 1.

12. A system for adjusting images, comprising:
a. an input module for receiving a first image with a first camera having a first lens distortion and for receiving a second image with a second camera having a second lens distortion;
b. an unwarping module for unwarping the first and second images using transformations corresponding to the first and second lens distortions; and
c. a warping module for re-warping the first and second images with a common lens distortion transformation.

13. The system of claim 12, further comprising a selection module for receiving an input from a user indicating a common lens distortion transformation to employ in the re-warping.

14. The system of claim 13, wherein the selection module displays a choice of an inverse of the first lens distortion transformation or an inverse of the second lens distortion transformation to use as the common lens distortion transformation.

15. The system of claim 13, wherein the selection module displays a choice of a linear combination of an inverse of the first lens distortion transformation and an inverse of the second lens distortion transformation to use as the common lens distortion transformation.

16. The system of claim 15, wherein the selection module displays a choice of an average of the inverse of the first lens distortion transformation and the inverse of the second lens distortion transformation to use as the common lens distortion transformation.

17. The system of claim 12, further comprising a modification module for performing a task on the unwarped images.

18. The system of claim 17, wherein the modification module is configured to perform a step of match-moving, compositing, plate preparation, animating, rendering, or compositing on one or both of the first or second unwarped images.
